(19) United States
(12) Patent Application Publication
(10) Pub. No.: US 2011/0234789 A1
(43) Pub. Date: Sep. 29, 2011

(54) RECEIVING ASSEMBLY COMPONENT RECOGNITION STRUCTURE, AND ASSEMBLY INFORMATION RECOGNITION APPARATUS AND ASSEMBLY PROCESSING APPARATUS THAT USE THE STRUCTURE

(76) Inventor: Naoki Koike, Kanagawa (JP)

(21) Appl. No.: 12/952,332

(22) Filed: Nov. 23, 2010

(30) Foreign Application Priority Data
Mar. 29, 2010 (JP) P2010-076233

(51) Int. Cl. H04N 7/18

(52) U.S. Cl. 348/95; 348/E07.085

(57) ABSTRACT

A structure for recognizing a receiving assembly component, comprising:
a recognition reference plane that is provided in a portion of an assembly base on a predetermined area of which there is placed a receiving assembly component used for assembling an assembly component and that serves as a reference used for recognizing layout information about a position and an attitude of the assembly base; and
a recognition indicator element that is provided on the recognition reference plane so that an imaging tool performs imaging operation and that has, at a predetermined positional relationship, four unit pattern marks or more formed such that a density pattern of each of the unit pattern marks sequentially changes from a center position to a periphery of the mark.

The present application claims priority from Japanese Patent Application No. 2010-076233 filed on Mar. 29, 2010, the entire content of which is incorporated herein by reference.

### BACKGROUND OF INVENTION

### Field of the Invention

The present invention relates to a receiving assembly component recognition structure, as well as relating to an assembly information recognition apparatus and an assembly processing apparatus that use the structure.

### SUMMARY OF INVENTION

According to an aspect of the invention, a structure for recognizing a receiving assembly component includes:

a recognition reference plane that is provided in a portion of an assembly base on a predetermined area of which there is placed a receiving assembly component used for assembling an assembly component and that serves as a reference used for recognizing layout information about a position and an attitude of the assembly base; and

a recognition indicator element that is provided on the recognition reference plane so that an imaging tool performs imaging operation and that has, at a predetermined positional relationship, four unit pattern marks or more formed such that a density pattern of each of the unit pattern marks sequentially changes from a center position to a periphery of the mark.

### BRIEF DESCRIPTION OF THE DRAWINGS

FIG. 1A is a descriptive view showing an overview of an exemplary embodiment of a structure for recognizing a receiving assembly component to which the present invention applies and an assembly information recognition apparatus and an assembly processing apparatus using the structure, and FIG. 1B is a descriptive view showing an example recognition indicator element used in the exemplary embodiment;

FIG. 2 is a descriptive view showing an overall structure of the assembly processing apparatus of the first exemplary embodiment;

FIG. 3A is a descriptive view showing an example assembly pallet provided with a pattern marker used in the first exemplary embodiment, and FIGS. 3B and 3C are descriptive views showing an example structure of a unit pattern mark that is one element of the pattern marker;

FIG. 4A is a descriptive view schematically showing a characteristic of the unit pattern mark of the pattern marker used in the first exemplary embodiment, and FIG. 4B is a descriptive view showing an example structure of a marker used in a comparative mode;

FIG. 5 is a descriptive view showing a principle on the basis of which a position and an attitude of an assembly component are determined by means of the pattern marker used in the first exemplary embodiment;

FIG. 6 is a descriptive view showing an example manufacture of the pattern marker used in the first exemplary embodiment;

FIG. 7 is a descriptive view showing an example structure and dimensions of the pattern marker used in the first exemplary embodiment;

FIG. 8A is a descriptive view showing a configuration in which an imaging plane of a camera serving as an imaging tool is set at a face-up measurement position with respect to a point of center origin of the pattern marker, FIG. 8B is a descriptive view showing a configuration in which the imaging plane of the camera serving as an imaging tool is moved in parallel to the face-up measurement position shown in FIG. 8A, and FIG. 8C is a descriptive view showing a configuration in which the imaging plane of the camera serving as an imaging tool is placed at a non-face-up measurement position that is not parallel to an indication plane of the pattern marker;

FIG. 9A is a descriptive view schematically showing a configuration in which the imaging plane of the camera serving as an imaging tool is placed at the face-up measurement position with respect to the point of center origin of the pattern marker and

FIG. 9B is a descriptive view showing measurement accuracy achieved in the case shown in FIG. 9A;

FIG. 10 is a flowchart showing an assembly processing process of the assembly processing apparatus of the first exemplary embodiment;

FIG. 11A is a descriptive view showing a process of positioning the assembly pallet, FIG. 11B is a planar descriptive view of the process, and FIG. 11C is a descriptive view schematically showing assembly processing performed when the assembly pallet is inclined;

FIG. 12A is a descriptive view showing an example positioning structure of an assembly processing apparatus of a comparative mode, and FIG. 12B is a descriptive view showing an example positioning structure of the assembly processing apparatus of the comparative mode, wherein (I) they are front descriptive views of the positioning structure and (II) they are planar descriptive views of the positioning structure;

FIG. 13 is a descriptive view showing a mode of modification of the assembly processing apparatus of the first exemplary embodiment;

FIG. 14A is a descriptive view showing a pattern marker of an assembly pallet used in an assembly processing apparatus of a second exemplary embodiment, and FIG. 14B is a descriptive view showing a mode of modification of the pattern marker of the assembly pallet used in the second exemplary embodiment;

FIGS. 15A and 15B are descriptive views showing an example structure of the pattern marker used in the second exemplary embodiment;

FIGS. 16A and 16B are descriptive views showing example fixing of a pattern marker of a third exemplary embodiment, wherein (I) they are cross sectional descriptive views of the pattern marker, and (II) they are planar descriptive views of the pattern marker;

FIGS. 17A and 17B are descriptive views showing another example fixing of the pattern marker of the third exemplary embodiment, wherein (I) they are cross sectional descriptive views of the pattern marker, and (II) they are planar descriptive views of the pattern marker;

FIG. 18A is a descriptive view showing a principal block of an assembly processing apparatus of the third exemplary embodiment, and FIG. 18B is a planar descriptive view of an assembly pallet;

FIG. 19A is a descriptive view showing a principal block in a mode of modification of the assembly processing apparatus of the third exemplary embodiment, and FIG. 19B is a planar descriptive view of the assembly pallet;

FIG. 20A is a descriptive view showing a principal block in a mode of another modification of the assembly processing apparatus of the third exemplary embodiment, and FIG. 20B is a planar descriptive view of the assembly pallet; and

FIG. 21 shows a principal block of an assembly processing apparatus (a connector device) of a fourth exemplary embodiment, wherein FIG. 21A is a descriptive view showing the connector device before performance of assembly operation, and FIG. 21B is a descriptive view showing the connector device after performance of assembly operation.

### DESCRIPTION OF EXEMPLARY EMBODIMENTS

Overview of Exemplary Embodiments

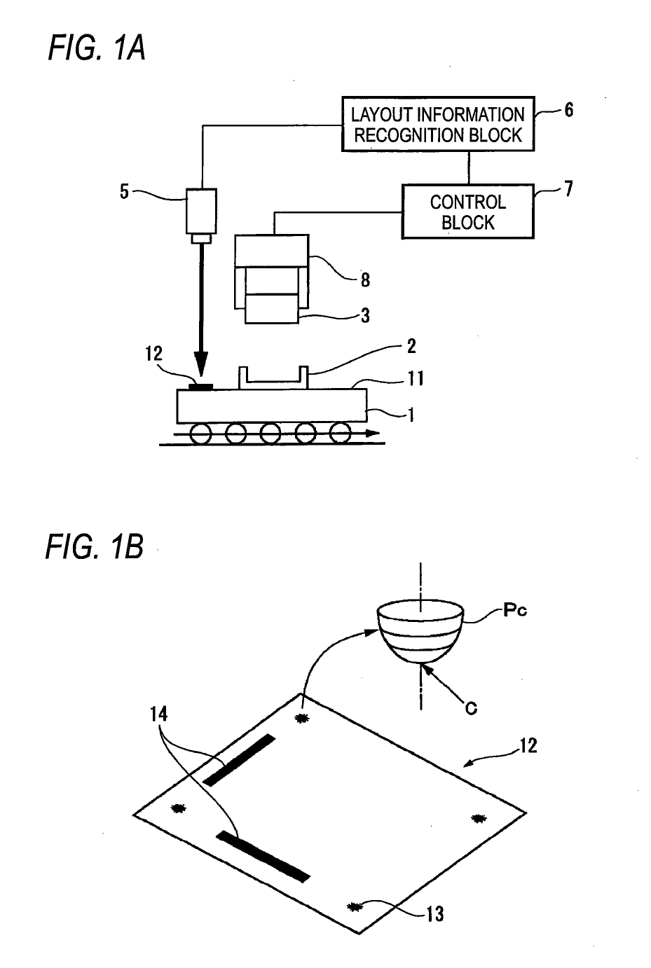

In present exemplary embodiments, as shown in FIGS. 1A and 1B, a typical configuration of a structure for recognizing a receiving assembly component includes: a recognition reference plane 11 that is provided in a portion of an assembly base 1 on a predetermined area of which there is placed a receiving assembly component 2 used for assembling an assembly component 3 and that serves as a reference used for recognizing layout information about a position and an attitude of the assembly base 1; and a recognition indicator element 12 that is provided on the recognition reference plane 11 so that an imaging tool 5 may perform imaging operation and that has, at a predetermined positional relationship, four unit pattern marks 13 or more formed such that a density pattern Pc of each of the unit pattern marks sequentially changes from a center position C to a periphery of the mark.

The configuration corresponds to an addition of the recognition reference plane 11 and the recognition indicator element 12 to the assembly base 1. Layout information about the receiving assembly component 2 is indirectly recognized from the layout information about the assembly base 1.

In relation to such technical means, the recognition indicator element 12 having four unit pattern marks or more is sufficient. When three unit pattern marks are provided, plural of three-dimensional positions may exist in connection with the attitude of the assembly base, which may make it impossible to determine a three-dimensional position

The unit pattern mark 13 whose density pattern Pc sequentially changes is sufficient. The density pattern is not limited to a pattern that exhibits higher density at the center position C than at the periphery of the mark and also includes a configuration in which the center position C exhibits lower density than does the periphery. Although there is mentioned a technique for displaying a change in density pattern Pc of the unit pattern mark 13 in the form of gradations, displaying the change in density pattern is not limited to the technique. The change in density pattern may also be displayed in the form of a dot image. Although the unit pattern mark 13 may be directly plotted by use of a printing technique, the marks may also be represented by utilization of retroreflection, like inscribed surface patterns for die molding; for instance, a corner cube (a tool that reflects light, or the like, to its original direction by utilization of a property of a corner of a cubical inner surface).

Moreover, plural of imaging tools 5 may also be used. However, from a viewpoint of simplification of the structure of the apparatus, one imaging tool is preferable.

As shown in FIGS. 1A and 1B, another typical configuration of a structure for recognizing a receiving assembly component, comprises: a recognition reference plane 11 that is provided in a portion of a receiving assembly component 2 used for putting an assembly component 3 into a predetermined area of an assembly base 1 and that serves as a reference used for recognizing layout information about a position and an attitude of the receiving assembly component 2; and a recognition indicator element 12 that is provided on the recognition reference plane 11 so that an imaging tool 5 can perform imaging operation and that has, at a predetermined positional relationship, four unit pattern marks 13 or more formed such that a density pattern Pc of each of the unit pattern marks sequentially changes from a center position C to a periphery of the mark.

The configuration corresponds to an addition of the recognition reference plane 11 and the recognition indicator element 12 to the receiving assembly component 2. Layout information about the receiving assembly component 2 is directly recognized.

The foregoing structures for recognizing the receiving assembly component 2 have a commonality or are closely relevant to each other in terms of a technical significance.

A preferred configuration of the recognition indicator element 12 is now described.

First, a preferred configuration of the recognition indicator element 12 is displaying a change in the density pattern Pc of the unit pattern mark 13 in the form of a dot image. In the configuration, a dot image display is provided; hence, an inkjet or electrophotographic image forming apparatus can form the unit pattern marks 13 of the recognition indicator element 12.

Another configuration of the recognition indicator element 12 includes four unit pattern marks 13 provided on a single plane of an article to be recognized. For instance, a position and an attitude of the article to be recognized can be determined without making one of the four unit pattern marks 13 on a plane differing from a plane on which the three unit pattern marks are provided.

Moreover, from the viewpoint of easy changing of the recognition indicator element 12, it is better to form the recognition indicator element displayed on a card that is removably attached to an article to be recognized.

Further, when the article to be recognized include different types of articles, it is better to provide the recognition indicator element 12 with four unit pattern marks 13 or more and type indication marks 14 used for recognizing type information other than layout information about a position and an attitude of the article to be recognized, as shown in FIG. 1B.

In the present exemplary embodiment, the assembly information recognition apparatus is constructed by utilization of the structure for recognizing the receiving assembly component 2.

As shown in FIGS. 1A and 1B, an assembly information recognition apparatus comprises: a recognition indicator element 12 that is provided in a portion of an assembly base 1 on a predetermined area of which there is placed a receiving assembly component 2 used for assembling an assembly component 3 or a portion of the receiving assembly component 2 and that has, at a predetermined positional relationship, four unit pattern marks 13 or more formed such that a density pattern Pc of each of the unit pattern marks sequentially changes from a center position C to a periphery of the mark; an imaging tool 5 that is disposed opposite the assembly base 1 or the receiving assembly component 2 and that captures an image of the recognition indicator element 12; and a layout information recognition block 6 that uses at least imaging information about the recognition indicator element 12 whose image has been captured by the imaging tool 5, thereby recognizing layout information about a position and an attitude of the assembly base 1 or the receiving assembly component 2.

The “assembly information” signifies information required to assemble the assembly component 3 (layout information about the position and the attitude of the assembly base 1 or the receiving assembly component 2).

A measurement position for the imaging tool 5 can arbitrarily be set. However, in order to enhance measurement accuracy, it is preferable to place the imaging tool 5 at a non-face-up measurement position where the imaging plane of the imaging tool 5 and the surface of the article to be recognized on which the recognition indicator element 12, which lies in the view range of the imaging tool, is to be formed do not face up each other. In this case, another preferred configuration includes fixedly placing the imaging tool 5 at the non-face-up measurement position. Alternatively, there may also be adopted a configuration in which the imaging tool 5 is supported so as to be movable to enable performance of measurement of both the face-up measurement position and the non-face-up measurement position. Moreover, there may also be adopted a configuration in which the imaging tool 5 is supported so as to be movable to enable measurement of the non-face-up measurement position in a plurality of stages.

Furthermore, the layout information recognition block 6 may also adopt any recognition technique, so long as the technique is an algorithm that recognizes the layout information about the position and the attitude of the article to be recognized (the assembly base 1 or the receiving assembly component 2).

Further, an assembly processing apparatus is constructed, so long as the foregoing assembly information recognition apparatus is utilized.

The assembly processing apparatus includes the aforementioned assembly information recognition apparatus; a control block 7 that generates a control signal from layout information about the position and the attitude of the assembly base 1 or the receiving assembly component 2 recognized by the assembly information recognition apparatus and that controls operation of the assembly base 1 for putting an assembly component 3 to the receiving assembly component 2; and a processing mechanism 8 that performs operation for putting the assembly component 3 into the receiving assembly component 2 according to a control signal generated by the control block 7.

In relation to such technical means, a measurement position for the imaging tool 5 can arbitrarily be set. However, in order to enhance measurement accuracy, it is preferable to place the imaging tool 5 at a non-face-up measurement position where the imaging plane of the imaging tool 5 and the surface of the article to be recognized on which the recognition indicator element 12, which lies in the view range of the imaging tool, is to be formed do not face up each other. In this case, another preferred configuration includes fixedly placing the imaging tool 5 at the non-face-up measurement position. Alternatively, there may also be adopted a configuration in which the imaging tool 5 is supported so as to be movable to enable performance of two-step measurement of both the face-up measurement position and the non-face-up measurement position.

Furthermore, the layout information recognition block 6 may also adopt any recognition technique, so long as the technique is an algorithm that recognizes the layout information about the position and the attitude of the article to be recognized (the assembly base 1 or the receiving assembly component 2).

Furthermore, an assembly processing apparatus is constructed, so long as the foregoing assembly information recognition apparatus is utilized.

The assembly processing apparatus includes the aforementioned assembly information recognition apparatus; a control block 7 that generates a control signal from layout information about the position and the attitude of the recognition target component, which is made up of the assembly base 1 or the receiving assembly component 2, recognized by the assembly information recognition apparatus and that controls operation of the assembly base 1 for putting an assembly component 3 to the receiving assembly component 2; and a processing mechanism 8 that performs operation for putting the assembly component 3 into the receiving assembly component 2 according to a control signal generated by the control block 7.

Such technical means broadly encompasses, as “assembly processing,” processing, such as assembly of the assembly component 3 to the receiving assembly component 2.

Further, the processing mechanism 8 designates a manipulator; for instance, a robot hand.

Moreover, a preferable mechanism for supporting the imaging tool 5 is a configuration in which the processing mechanism 8 doubles also as a mechanism for supporting the imaging tool 5.

The present invention is hereunder described in more detail by reference to exemplary embodiments shown in the accompanying drawings.

### First Exemplary Embodiment

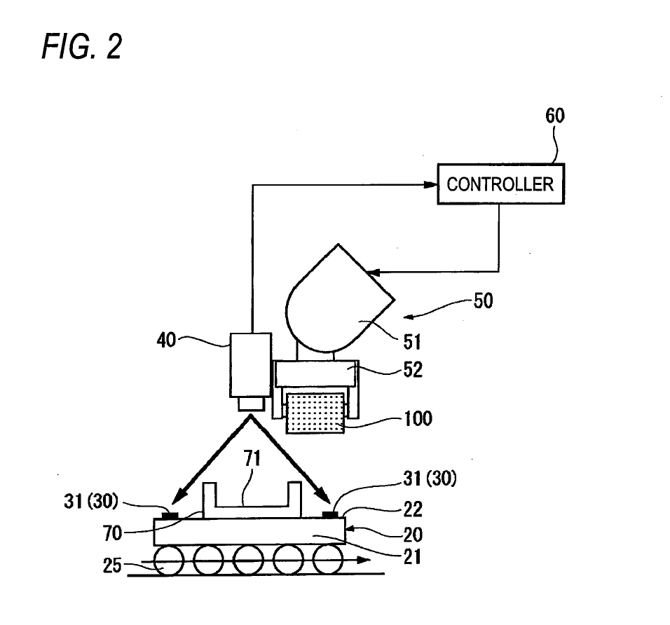

FIG. 2 is a descriptive view showing an overall structure of an assembly processing apparatus of a first exemplary embodiment.

<Overall Configuration of the Assembly Processing Apparatus>

In the drawing, the assembly processing apparatus is arranged so as to place a receiving assembly component 70 at a predetermined location on an assembly pallet 20 (equivalent to an assembly base) and put an assembly component 100 into the receiving assembly component 70.

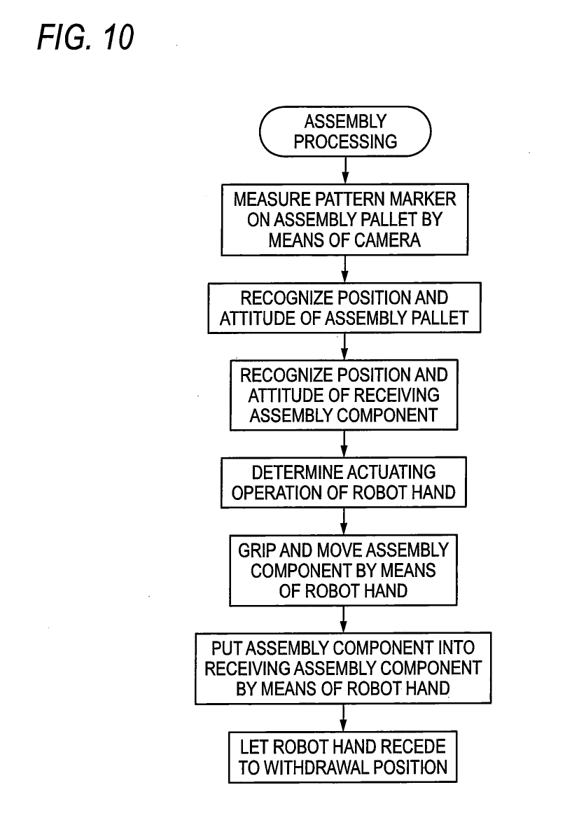

In the present exemplary embodiment, the assembly processing apparatus has a pattern marker 30 serving as a recognition indicator element provided on the assembly pallet 20 used for recognizing layout information about a position and an attitude of the assembly pallet 20; a camera 40 that captures an image of the pattern marker 30 of the assembly pallet 20; a robot 50 for moving the assembly component 100 to a predetermined location with respect to the receiving assembly component 70 of the assembly pallet 20; and a controller 60 that controls imaging timing of the camera 40, receives an input of imaging information from the camera 40, and recognizes layout information about a position and an attitude of the assembly pallet 20, and controls motion of the robot 50 according to the thus-recognized layout information and along a flowchart shown in FIG. 10 to be described later.

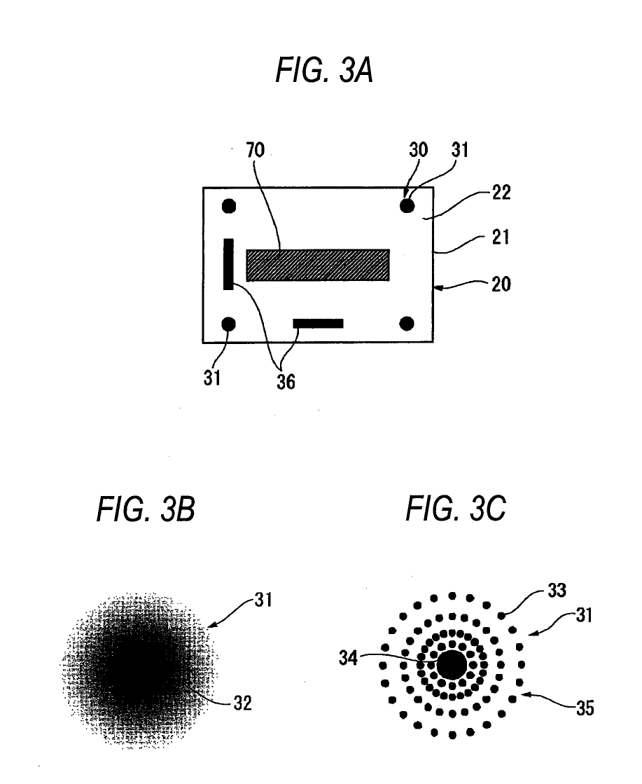

In the exemplary embodiment, the assembly pallet 20 has a plate-like pallet main body 21 that moves along a conveyance conveyor 25, as shown in FIGS. 2 and 3A. The receiving assembly component 70 is fixedly positioned at a previously-cut area of the pallet main body 21.

The robot 50 has a robot arm 51 that can be actuated by means of multiaxial joints. A robot hand 52 capable of performing gripping action is attached to an extremity of the robot arm 51. Processing operation to be performed by the robot hand 52 is instructed according to input locus information, such as a motion capture. A correction is made to the processing operation to be performed by the robot hand 52 according to the imaging information from the camera 40.

In the present exemplary embodiment, the assembly component 100 is gripped with the robot hand 52, and the assembly component 100 is put into the receiving assembly component 70 on the assembly pallet 20. The receiving assembly component 70 of the present exemplary embodiment has a receiving assembly indentation 71. The assembly component 100 is fit and put into the receiving assembly indentation 71.

In the present exemplary embodiment, the camera 40 is fixed to a portion of the robot hand 52 and set at the predetermined measurement position by means of the robot hand 52.

<Pattern Marker>

In the exemplary embodiment, as shown in FIG. 3A, the pattern marker 30 takes a top surface 22 of the pallet main body 21 of the assembly pallet 20 as a recognition reference plan. The pattern marker 30 has unit pattern marks 31 respective placed at four corners of the top surface 22 and type indication marks 36 provided along two adjacent sides of the top surface 22 of the pallet main body 21, as shown in FIG. 3A.

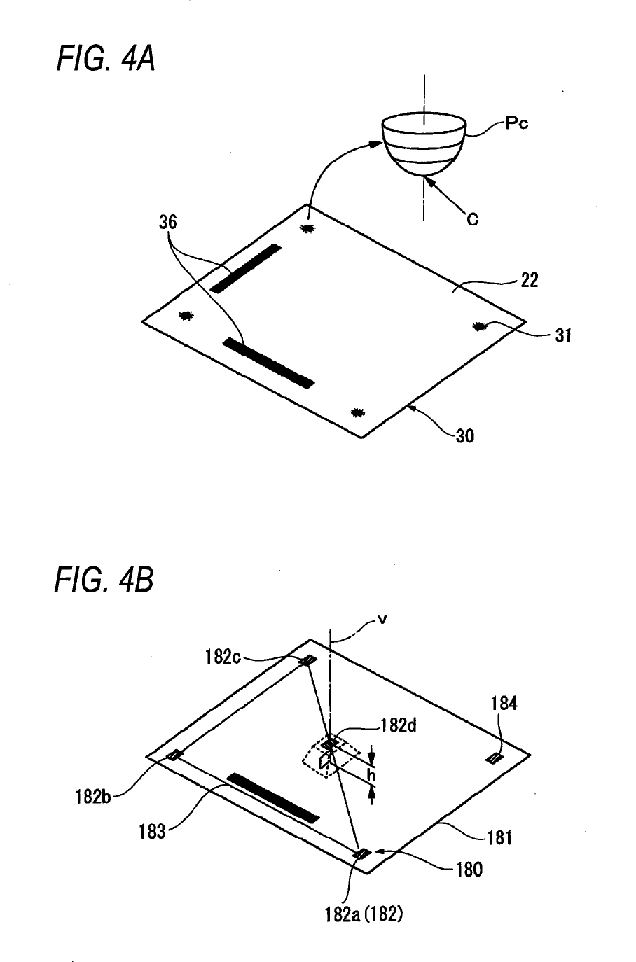

As shown FIGS. 3B and 4A, one typical configuration of the unit pattern mark 31 is illustrated as a gradation 32 having a density pattern Pc that exhibits the highest density at a center position C and that sequentially changes so as to become less dense with an increasing distance toward a periphery of the mark.

As shown FIGS. 3C and 4A, another typical configuration of the unit pattern mark 31 is illustrated as a dot pattern. In the dot pattern, the most dense distribution of dots 33 appears at the center position C, thereby forming a high density region 34, and the distribution of the dots 33 becomes gradually coarse toward a periphery of the mark, thereby forming a low density region 35. In this case, the density distribution can be given to the unit pattern mark by means of changing a diameter size of the dot 33, spacing between the dots, and a layout position.

In particular, the dot pattern type is preferable because the dot pattern is easily made by means of printing utilizing an inkjet image forming apparatus or an electrophotographic image forming apparatus.

Meanwhile, for instance, when the receiving assembly component 70 to be placed on the assembly pallet 20 is of a plurality of types (e.g., color types, size types, and the like), the type indication marks 36 act as ID (identification) indications used for finding matching to receiving assembly components 70 of a corresponding type. In the present exemplary embodiment, the type indication marks 36 are provided at two locations but can also be provided at one location. Alternatively, the type indication marks can also be placed at three locations or more in a split manner.

—Comparison with an LED Display Plate—

Unlike the pattern marker 30, an LED indication plate 180 shown in FIG. 4B has four LEDs 182 (182a to 182d) provided on a substrate 181. The three LEDs 182 (182a to 182c) of the four LEDs 182 are placed on a single plane of the substrate 181. The remaining LED 182 (182d) is set on a vertical line “v” that is spaced “h” apart from a triangular reference plane 183 including the three LEDs 182 as apexes. A position and an attitude of the triangular reference plane 183 is determined from a positional relationship between the triangular reference plane 183 and the LED 182 (182d) on the vertical line “v.” Reference numeral 184 designates an LED for identification.

The position and the attitude of the assembly pallet 20 can surely be recognized even by means of the LED indication plate 180. However, an electric power source for enabling use of the LED 182 is required. The pattern marker 30 of the present exemplary embodiment is therefore more advantageous in that such a power source is not required.

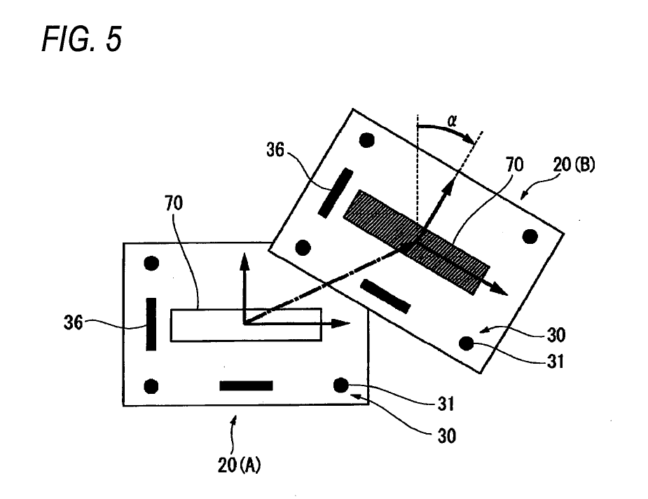

Further, the LED indication plate 180 adopts a technique for arranging the four LEDs 182 in a three-dimensional layout, thereby enhancing the accuracy of recognition of the position and attitude of the LED indication plate 180. However, in the pattern marker 30, each of the unit pattern marks 31 has a density distribution that sequentially changes toward a periphery of the mark from the center position C. Therefore, the center position C (i.e., a point where the highest density is exhibited) of the density distribution can be calculated with high accuracy by means of a density distribution approximation expression. For this reason, even when four unit pattern marks 31 are placed on a single plane because of high accuracy of recognition of the unit pattern marks 31, the position of an apex corresponding to the center position of the four unit pattern marks 31 is recognized. As a result, even if the assembly pallet 20 has changed from a position A to a position B incidental to rotation effected through a rotation angle α as shown in FIG. 5, the position and the attitude of the top surface 22 that is a recognition reference plane of the assembly pallet 20 will be accurately recognized.

In the present exemplary embodiment, the unit pattern marks 31 are provided in number of four on the single plane. However, the number of unit pattern marks is not limited to four. The unit pattern marks 31 can also be provided at arbitrary six points, or the like. Specifically, the unit pattern marks can be appropriately selected, so long as the marks enable recognition of a three-dimensional position and attitude of the assembly pallet. The essential requirement is to provide the unit pattern marks 31 in number of four or more, and locations where the unit pattern marks 31 are to be placed are not limited to a single plane but can also be set over different planes.

—Example Generation of a Pattern Marker—

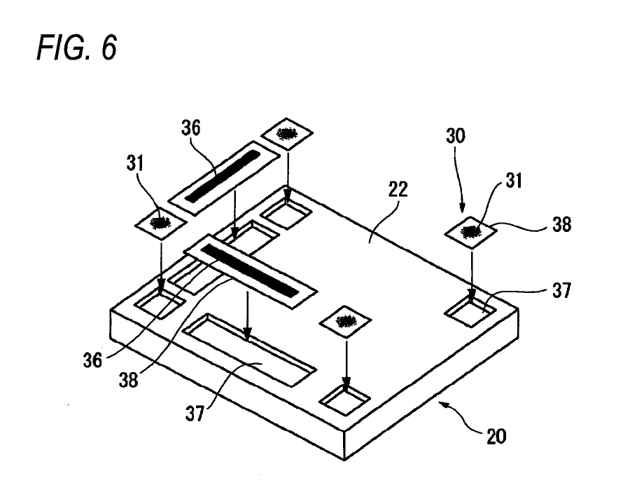

In the present exemplary embodiment, as shown in; for instance, FIG. 6, the pattern marker 30 includes attachment indentations 37 respectively made at four corners and along two sides of the top surface 22 of the assembly pallet 20. The unit pattern marks 31 and labels 38, each of which is printed with the type indication mark 36, are affixed to the respective attachment indentations 37. At this time, for instance, the depth of the attachment indentation 37 is selected so as to become equal to the thickness of the label 38. The unit pattern marks 31 and the type indication marks 36 are set so as to become flush with the top surface 22 that is to serve as the recognition reference plane. Although the pattern marker 30 is set so as to become flush with the top surface 22 that is to serve as the recognition reference plane, the pattern marker 30 does not always need to become flush with the top surface 22. Further, in the present exemplary embodiment, the labels 38 are affixed to the assembly pallet by way of the attachment indentations 37. The labels can also be affixed directly to the top surface 22 that is to serve as a recognition reference plane, without involvement of the attachment indentations 37.

Moreover, in the present exemplary embodiment, it is desirable to place the unit pattern marks 31 of the pattern marker 30 at certain space from respective edges of the top surface 22 of the assembly pallet 20.

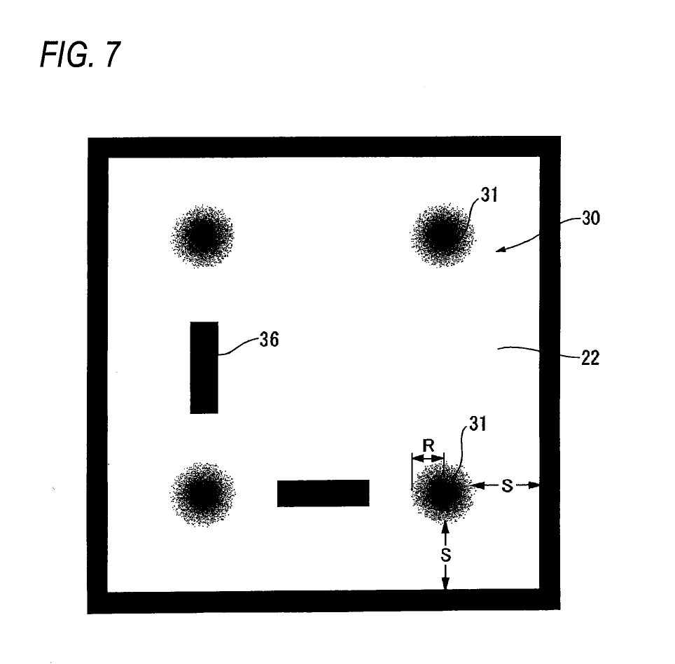

For instance, as shown in FIG. 7, provided that the radius of the unit pattern mark 31 is taken as R and that space between the outermost contour of the unit pattern mark 31 and the edge of the top surface 22 is taken as S, fulfillment of S>2R is desirable. This is attributable to an algorithm for detecting the center position C of the unit pattern mark 31 with high accuracy. A relationship of S>2R is fulfilled in such a way that a rectangular detection window to be superposed on a circular pattern of the unit pattern mark 31 does not overlap an edge (indicated by a black edge) of the top surface 22 of the assembly pallet 20. As a matter of course, a layout of the unit pattern mark 31 can arbitrarily be set, so long as a different detection algorithm is used for the pattern marker 30.

<Measurement Position of the Camera>

In the present exemplary embodiment, the camera 40 is disposed opposite the pattern marker 30 in order to make it possible to capture an image of the pattern marker 30 of the assembly pallet 20.

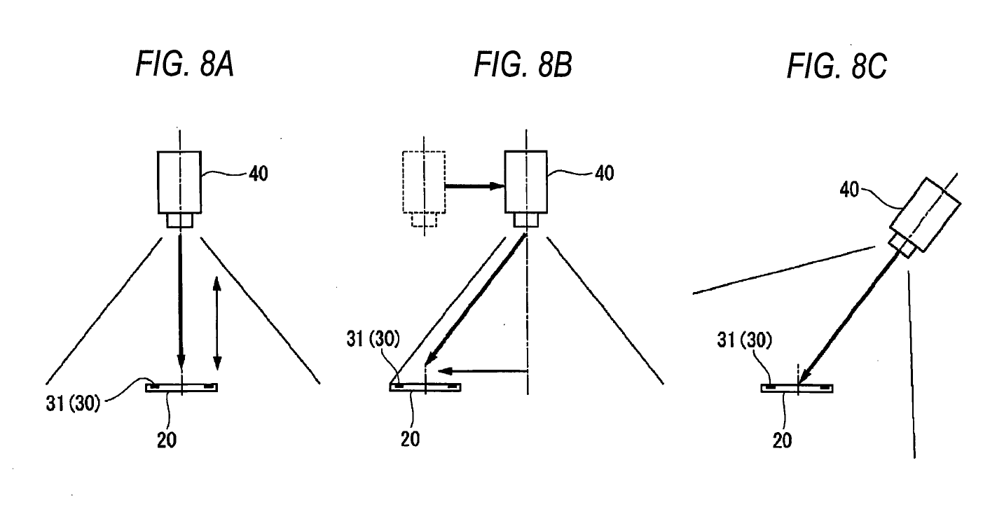

When study of a measurement position of the camera 40 achieved is performed at this time, configurations shown in FIGS. 8A to 8C are conceivable.

First, the configuration shown in FIG. 8A is for a case where a center position of an imaging plane (i.e., a center position of a view field range) of the camera 40 includes the center position of the four unit pattern marks 31 of the pattern marker 30 of the assembly pallet 20 and where the center position is a face-up measurement position where the center position directly faces up to the top surface 22 that is the recognition reference plane.

The configuration excites an apprehension of deterioration of accuracy of measurement of a distance between the camera 40 and the pattern marker 30.

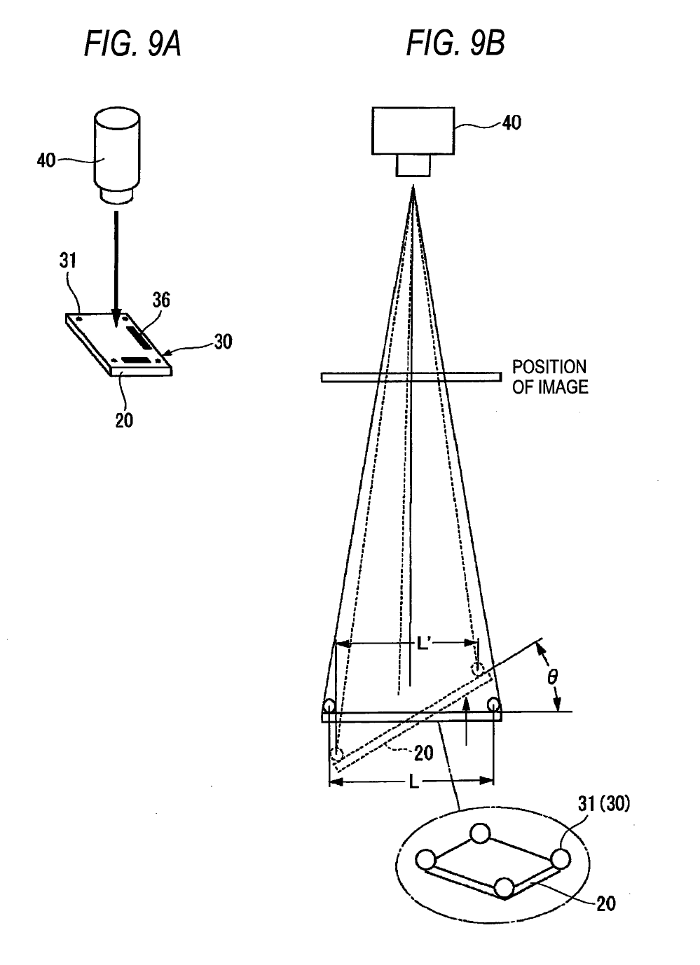

As shown in FIGS. 9A and 9B, when the camera 40 is disposed opposite the pattern marker 30, a widthwise dimension between the unit pattern marks 31 of the pattern marker 30 is taken as an image size L to be captured by the camera 40. Further, if a change in image size resultant from occurrence of a minute change in the pattern marker 30 by merely an amount of θ on the top surface 22 that is a recognition reference plane of the assembly pallet 20 is taken as L′, a relationship of L′=L×cos Φ will be fulfilled.

Therefore, the change L′ in image size becomes smaller than the original image size L, so that measurement accuracy is understood to become deteriorated.

Next, a configuration shown in FIG. 8B is for a case where the camera 40 is shifted in parallel with the surface of the pattern marker 30 in such a way that the center position of the view field range of the camera 40 from the position shown in FIG. 8(A) becomes offset from the center position of the four unit pattern marks 31 of the pattern marker 30, to thus become offset from the face up measurement position shown in FIG. 8A.

In this case, when compared with the accuracy of measurement achieved in the case shown in FIG. 8A, the accuracy of measurement of the camera 40 is further enhanced. However, the pattern marker 30 comes to a position that is offset from the center position of the view field range of the camera 40, and there is apprehension that measurement accuracy will become deteriorated under influence of a lens distortion of the camera 40. Even when a correction is made to lens distortion, measurement accuracy tends to become deteriorated at this time. Therefore, it is preferable to take an additional remedial measure.

On the contrary, a configuration shown in FIG. 8C is a case where the imaging plane of the camera 40 and the surface of the pattern marker 30 (equivalent to the top surface 22 of the assembly pallet 20 that is the recognition reference plane) do not face up to each other and where the center of the view field range of the camera 40 is placed in alignment with the center position of the four unit pattern marks 31 of a pattern marker 30. Specifically, the configuration shows that the imaging plane of the camera 40 is placed at an inclination with respect to the recognition reference plane of the pattern marker 30 as shown in FIG. 8C, and measurement accuracy of the camera 40 is enhanced. Namely, on the assumption of cases shown in FIGS. 9A and 9B, the configuration shown in FIG. 8C can be considered as a case where the assembly component is tilted by an image size L′. A change in image size is considered to come to L as a result of the assembly component having turned through B. In this case, the change in image size is L=L′/cos θ. Accordingly, as the change in θ becomes larger, a change in the value of cos θ becomes larger. The change in image size is accordingly given as a larger change.

Therefore, the configuration shown in FIG. 8C is understood to accomplish enhancement of the measurement accuracy of the camera 40.

<Assembly Processing>

Assembly processing (assembly processing for putting an assembly component into a receiving assembly component) to be performed by the assembly processing apparatus of the present exemplary embodiment is now described.

First, the controller 60 performs processing pertaining to a flowchart shown in FIG. 10 and sends a control signal to the camera 40 and the robot 50.

In the drawing, the controller 60 first measures the pattern marker 30 of the assembly pallet 20 by means of the camera 40. Subsequently, the controller 60 recognizes layout information about the position and the attitude of the assembly pallet 20, as well as indirectly recognizing layout information about the position and the attitude of the receiving assembly component 70 positioned on the assembly pallet 20.

The controller 60 determines moving motion of the robot hand 52 and lets the robot hand 52 grip the assembly component 100 in order to move the assembly component to a predetermined area.

The controller 60 then puts the assembly component 100 into the receiving assembly component 70 on the assembly pallet 20 by means of the robot hand 52 and causes the robot hand 52 to recede to a predetermined withdrawal position (e.g., a home position) at a point in time when the assembly operation is completed.

—Positional Accuracy of an Assembly Pallet—

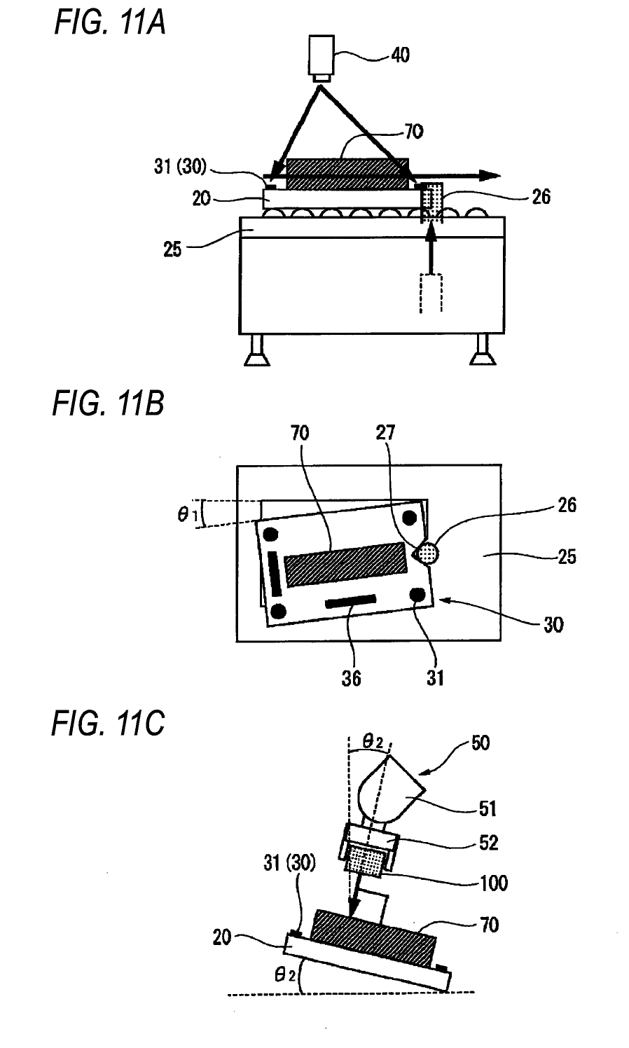

During such assembly processing, the assembly pallet 20 needs to be stopped upon arrival at an assembly processing stage. As shown in; for instance, FIGS. 11A and 11B, a stoppage structure of this type is provided with a stopper 26 that freely protrudes and recedes at a predetermined area of the conveyance conveyor 25; a V-shaped stopper notch 27 is made in an edge of the assembly pallet 20 opposing the stopper 26; and the stopper 26 is brought into contact with the stopper notch 27.

There arises an apprehension that the assembly pallet 20 will cause a rotational displacement by a rotational angle θ1 while taking the stopper 26 as a fulcrum as shown in FIG. 11B, or another apprehension that the attitude of the assembly pallet 20 will be inclined to a certain extent from a horizontal position depending on positional accuracy of the conveyance conveyor 25 as shown in FIG. 11C. Positional accuracy of the assembly pallet 20 achieved at the time of halt of the assembly pallet 20 will eventually become lower to a certain extent.

However, even when the assembly pallet 20 has caused a rotational displacement by a rotational angle θ1 or has been placed at an inclination angle θ2 on the conveyance conveyor 25, the camera 40 captures images of the pattern marker 30 on the assembly pallet 20, whereby layout information about the position and the attitude of the assembly pallet 20 is recognized. Therefore, an amount of rotational displacement or inclination of the assembly pallet 20 is fed back to the robot 50, whereby the assembly component 100 is accurately put into the receiving assembly component 70 on the assembly pallet 20.

—Mechanism for Positioning and Stopping an Assembly Pallet of a Comparative Mode—

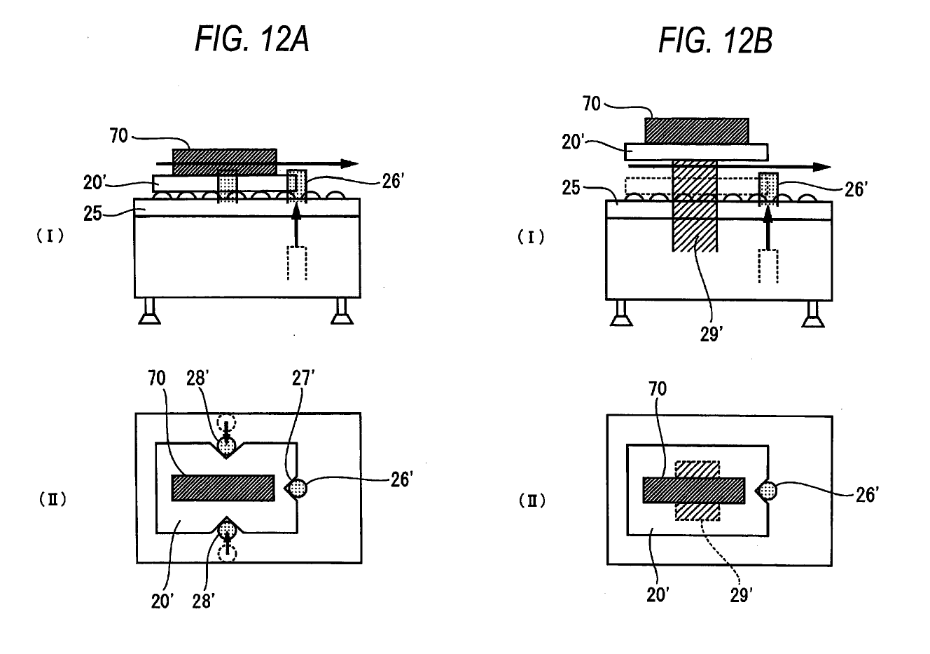

In relation to a technique of positioning an assembly pallet 20′ with high accuracy on occasion of the assembly pallet 20′ conveyed over the conveyance conveyor 25 being stopped for each process to undergo assembly operation, there are conceivable configurations. Namely, as shown in FIG. 12A, a configuration includes providing a side of the assembly pallet 20′ in its conveyance direction with a stopper 26′; making a pair of positioning member 28′ in the assembly pallet 20′ along a direction crossing the conveyance direction of the assembly pallet 20′; and positioning and restraining the assembly pallet 20′ in three directions. Alternatively, as shown in FIG. 12B, in addition to including the stopper 26′, a configuration also includes the assembly pallet 20′, which has been stopped by the stopper 26′, being elevated from the conveyance conveyor 25 by the elevation mechanism 29′ and being subsequently placed. However, these configurations excite an apprehension that the configuration of the mechanism will become complicate.

As mentioned above, according to assembly processing using the assembly pallet 20 of the exemplary embodiment, it is possible to accurately recognize layout information about the position and the attitude of the assembly pallet 20 without complication of the structure of the apparatus which would otherwise arise in the comparative example. Assembly processing of the present exemplary embodiment is preferable in that a position where the assembly component 100 is put into the receiving assembly component 70 on the assembly pallet 20 can accurately be determined by means of feeding back the layout information about the assembly pallet 20 to the robot 50.

—Modified Mode—

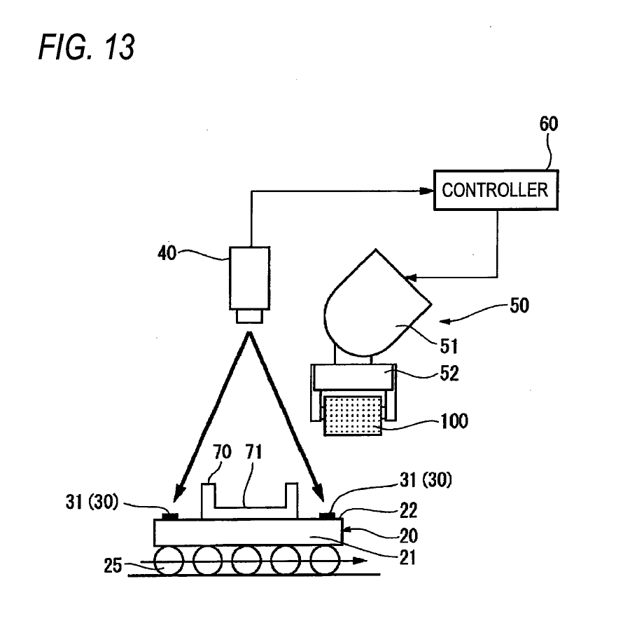

In the exemplary embodiment, the camera 40 is fixed to the robot hand 52 and can move to a desired measurement position by utilization of motion of the robot 50. The present invention is not limited to the exemplary embodiment. For instance, like a modification in FIG. 13, the camera 40 and the robot 50 can also be separated from each other, and the camera 40 can also be stationarily disposed at a predetermined measurement position.

In the present modification, all you need to do is to previously place the camera 40 at a position where the camera can capture an image of the pattern marker 30 of the assembly pallet 20. The camera 40 captures an image of the pattern marker 30, whereby the layout information about the position and the attitude of the assembly pallet 20 is recognized. It is thereby possible to indirectly recognize the layout information about the position and the attitude of the receiving assembly component 70 on the assembly pallet 20.

Therefore, the robot 50 accurately puts the assembly component 100 into the receiving assembly component 70 on the assembly pallet 20 in substantially the same manner as in the first exemplary embodiment.

When there is a request for changing the measurement position of the camera 40, it goes without saying that the camera 40 can also be supported by means of a movable support mechanism differing from the robot 50.

### Second Exemplary Embodiment

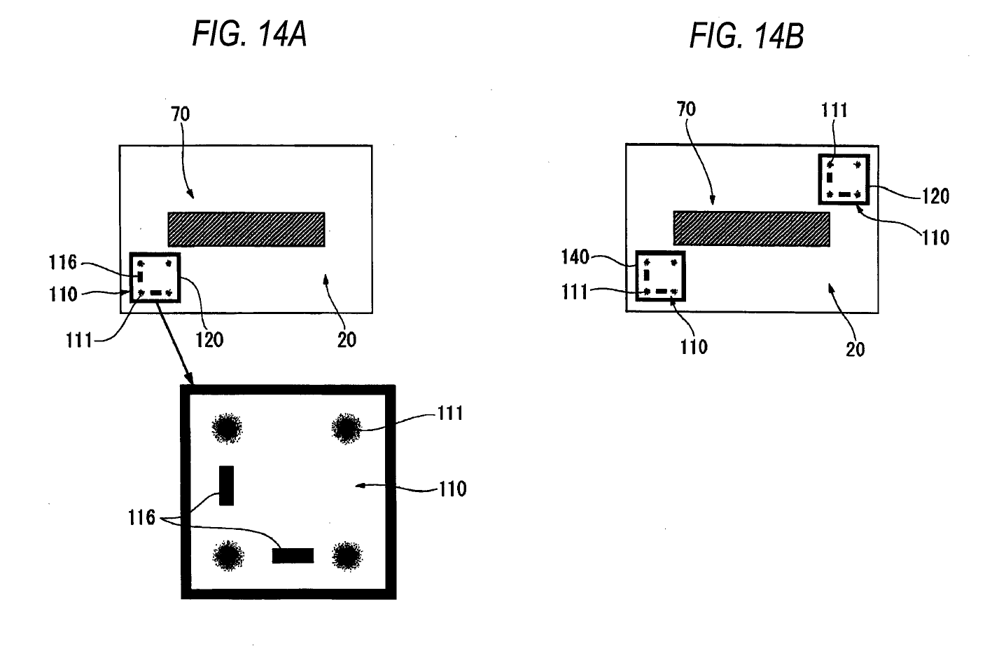

FIG. 14A shows a principal block of an assembly processing apparatus of a second exemplary embodiment.

In the drawing, the assembly processing apparatus is substantially identical with its counterpart described in connection with the first exemplary embodiment in terms of a basic configuration. A pattern marker 110 added to the assembly pallet 20 differs from the pattern marker 30 of the first exemplary embodiment. Elements similar to those of the first exemplary embodiment are assigned similar reference numerals, and their detailed descriptions are omitted here for brevity.

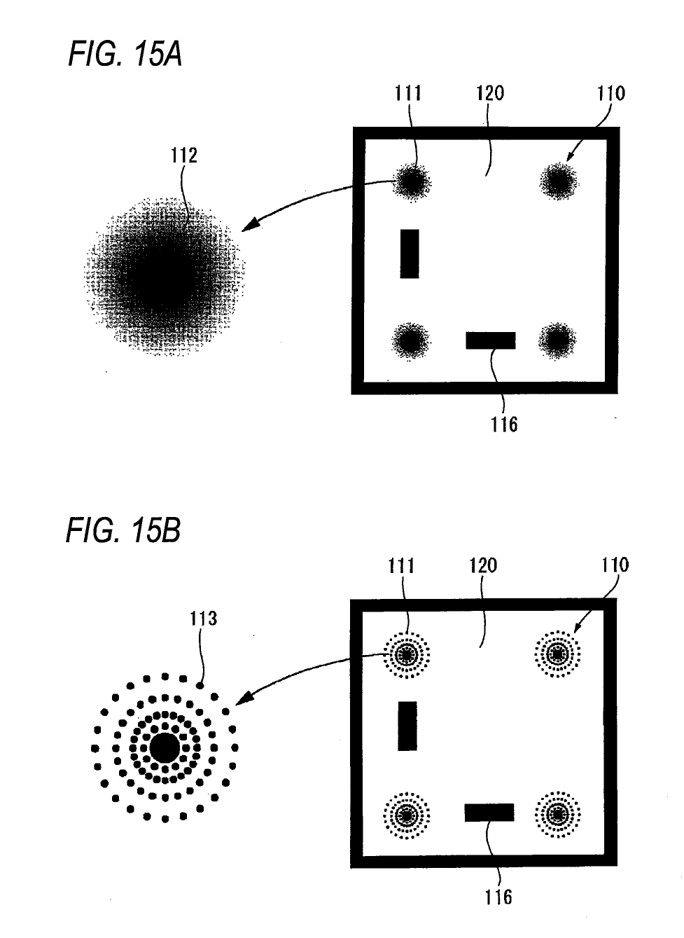

In the exemplary embodiment, the pattern marker 110 is printed on a front surface of a card 120, as shown in FIGS. 14A, 15A, and 15B. The card 120 is fixed to the attachment indentation 23 made in a portion (e.g., a corner) of the top surface 22 of the assembly pallet 20.

As shown in FIG. 15A, the pattern marker 110 is provided with a configuration including unit pattern marks 111 that are provided at four corners of the front surface of the card 120 and that are made up of; for instance, gradations 112, and type indication marks 116 laid along two sides of the front surface of the card 120 or a configuration including the unit pattern marks 111 that are provided at the four corners of the front surface of the card 120 and that are made up of; for instance, dot patterns 113, and the type indication marks 116 laid along the two sides of the front surface of the card 120.

<Method for Fixing the Pattern Marker>

The method for fixing the pattern marker 110 is given the following configurations.

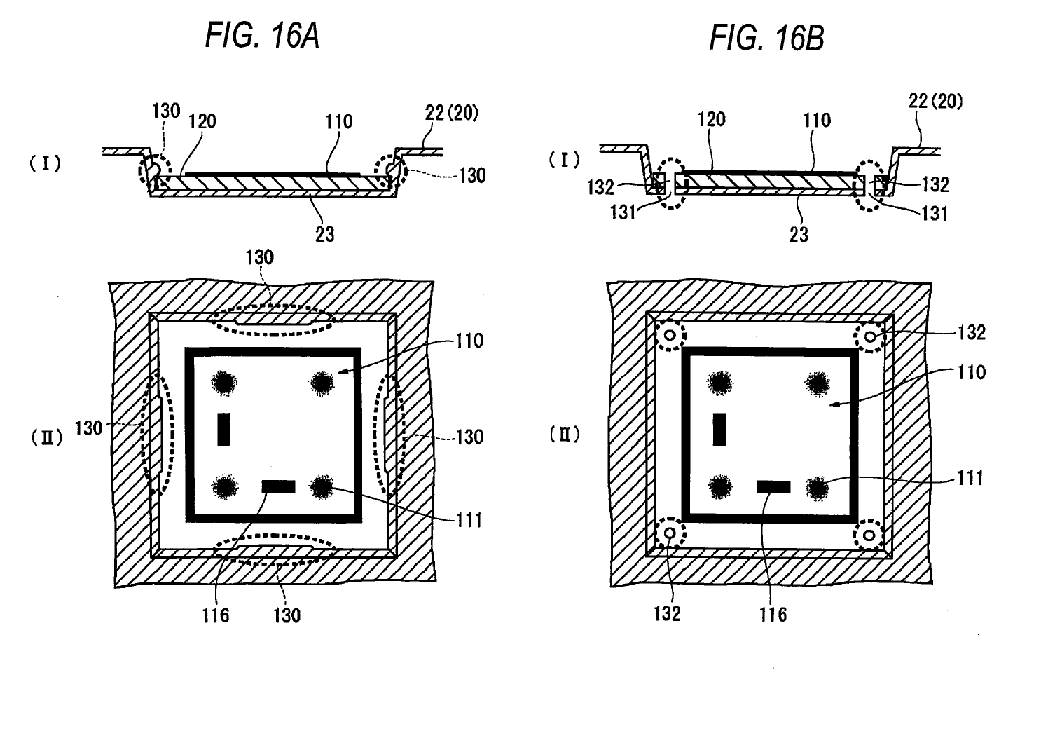

A configuration shown in FIG. 16A includes elastically deformable press protrusions 130 that are provided on peripheral walls of the attachment indentation 23 made in the top surface 22 of the assembly pallet 20, wherein the card 120 printed with the pattern marker 110 is housed in the attachment indentation 23 while the press protuberances 130 are elastically deformed, thereby pressing a periphery of the card 120 in the attachment indentation 23 by means of the press protrusions 130. In the exemplary embodiment, the card 120 can be removed while the press protrusions 130 are elastically deformed.

A configuration shown in FIG. 16B includes making attachment holes 131, 132 both in a bottom of the attachment indentation 23 formed on the top surface 22 of the assembly pallet 20 and at four corners of the card 120 printed with the pattern marker 110. The card 120 is fixed in the attachment indentation 23 by means of unillustrated fasteners.

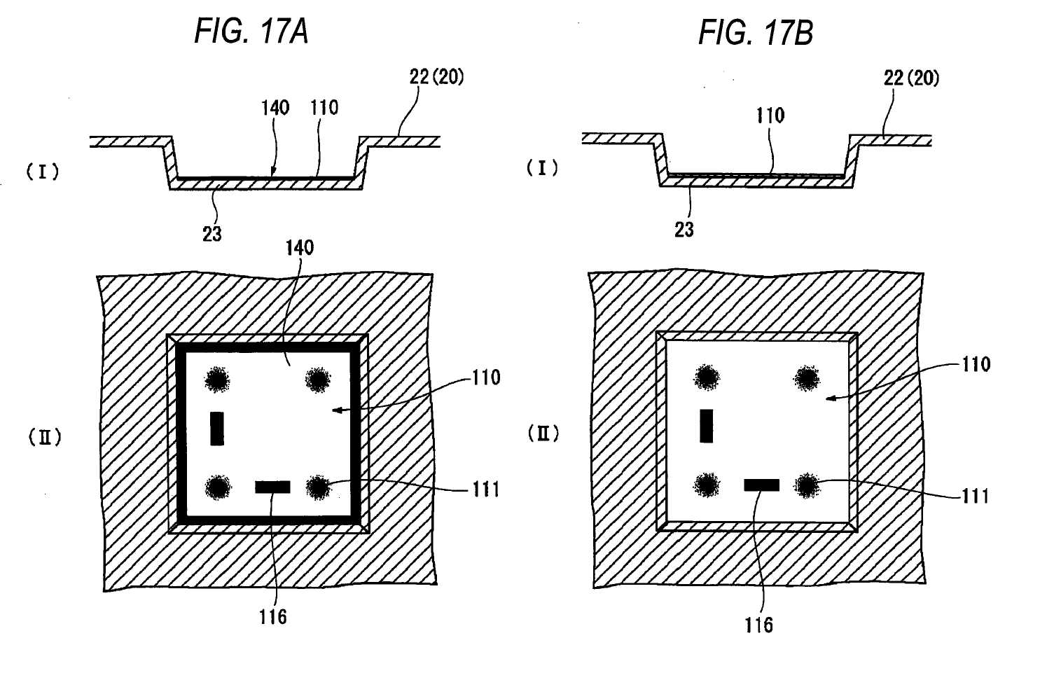

Moreover, a configuration shown in FIG. 17A includes printing the pattern marker 110 on a label 140 made of paper or a resin and affixing the label 140 to the bottom of the attachment indentation 23 of the assembly pallet 20.

A configuration shown in FIG. 17B also includes printing the pattern marker 110 directly on the bottom of the attachment indentation 23 of the top surface 22 of the assembly pallet 20.

As mentioned above, in the exemplary embodiment, the pattern marker 110 is provided in a portion of the assembly pallet 20. Accordingly, the pattern marker 110, which accounts for a portion of the assembly pallet 20, is measured by means of the camera 40, whereby the layout information about the position and the attitude of the assembly pallet 20 is recognized. It is possible to recognize the layout information about the position and the attitude of the receiving assembly component 70 on the assembly pallet 20. Processing for putting the assembly component 100 into the receiving assembly component 70 is performed in the same manner as in the first exemplary embodiment.

In the present exemplary embodiment, the pattern marker 110 is set in one corner of the top surface 22 of the assembly pallet 20. A location where the pattern marker 110 is to be set can be changed as required. For instance, the pattern marker 110 can also be provided at a position that is not any corners of the assembly pallet 20. Alternatively, as shown in FIG. 14B, a plurality of pattern markers 110 can also be disposed, like placing a pair of pattern markers 110 at diagonal corners of the top surface 22 of the assembly pallet 20, or the like. In particular, when the plurality of pattern markers 110 are placed, layout information about positions and attitudes of areas corresponding to the respective patter markers 110 can be recognized, so that the layout information about the assembly pallet 20 can be accurately recognized.

### Third Exemplary Embodiment

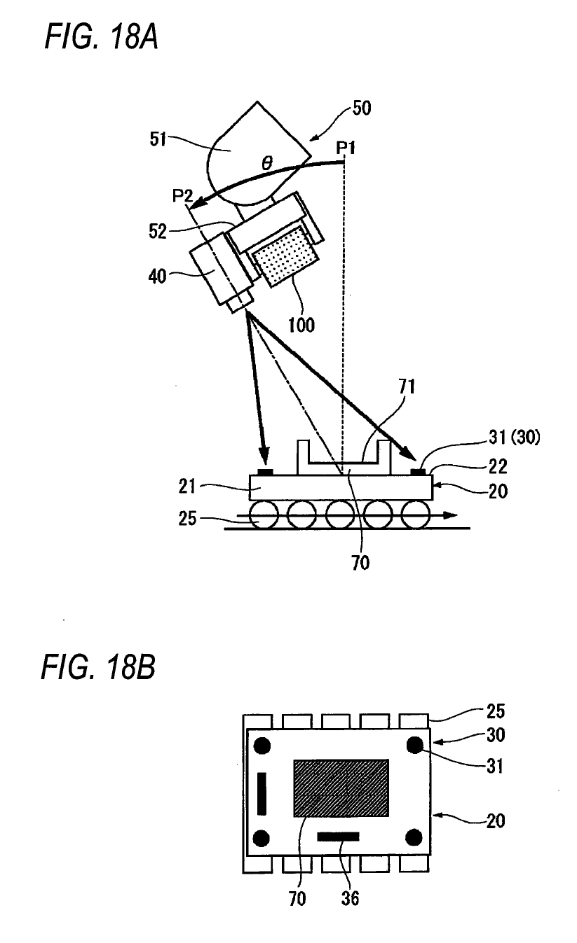

FIGS. 18A and 18B are descriptive views showing a principal block of an assembly processing apparatus of a third exemplary embodiment.

In the drawings, a basic structure of the assembly processing apparatus includes the camera 40 fixed to the robot hand 52 in substantially the same manner as in the first exemplary embodiment. However, unlike the first exemplary embodiment, the configuration includes a case where the imaging plane of the camera 40 does not face up to the recognition reference plane of the pattern marker 30 (equivalent to the top surface 22 of the assembly pallet 20) and where the center of a view field range of the camera 40 is aligned to the center position of the four unit pattern marks 31 of the pattern marker 30. As shown in FIG. 8C, the configuration corresponds to a case where the imaging plane of the camera 40 is arranged at an inclination angle θ with respect to the recognition reference plane of the pattern marker 30, and is preferable in view of enhancement of measurement accuracy of the camera 40.

In this case, there will arise no problem even when install operation of the camera 40 may include immediately moving the camera to a non-face-up measurement position P₂ inclined at the inclination angle θ with respect to the face-up measurement position P₁ or performing rough measurement of a first stage at the face-up measurement position P₁ and subsequently moving the camera to the non-face-up measurement position P₂, where highly accurate measurement operation of a second stage is performed.

Further, there will arise no problem even when the inclination angle θ may appropriately be selected. A preferred range of inclination angle is from 15° to 75°. In view of enhancement of measurement accuracy, it is better to selectively set the inclination angle particularly to 45° or thereabouts.

As described in connection with the present exemplary embodiment, in a configuration in which the camera 40 is attached to the robot hand 52, as the inclination angle θ becomes greater, the distance over which the robot hand 52 is moved to the location of the assembly pallet 20 after measurement also becomes greater, which will in turn affect production tact. For this reason, in view of production tact, a preferable inclination angle θ is as small as possible within a range in which measurement accuracy can be assured.

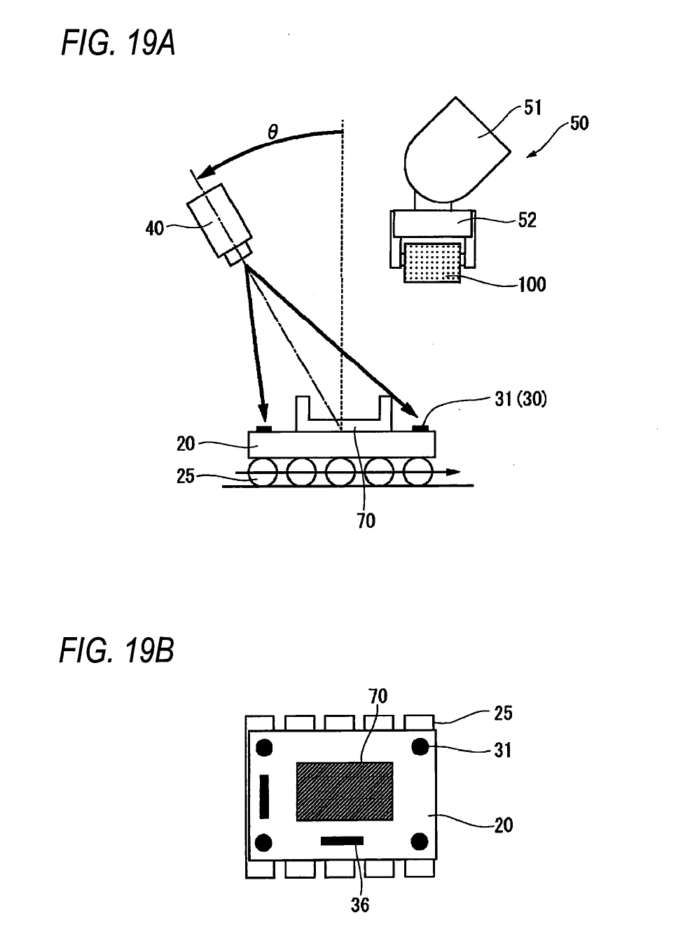

The assembly processing apparatus of the present exemplary Embodiment is not limited to the above-mentioned configuration. For instance, as shown in FIGS. 19A and 19B, the camera 40 and the robot 50 are separated apart from each other. The camera 40 is stationarily set at the non-face-up measurement position, and the pattern marker 30 on the assembly pallet 20 may also be measured with high accuracy.

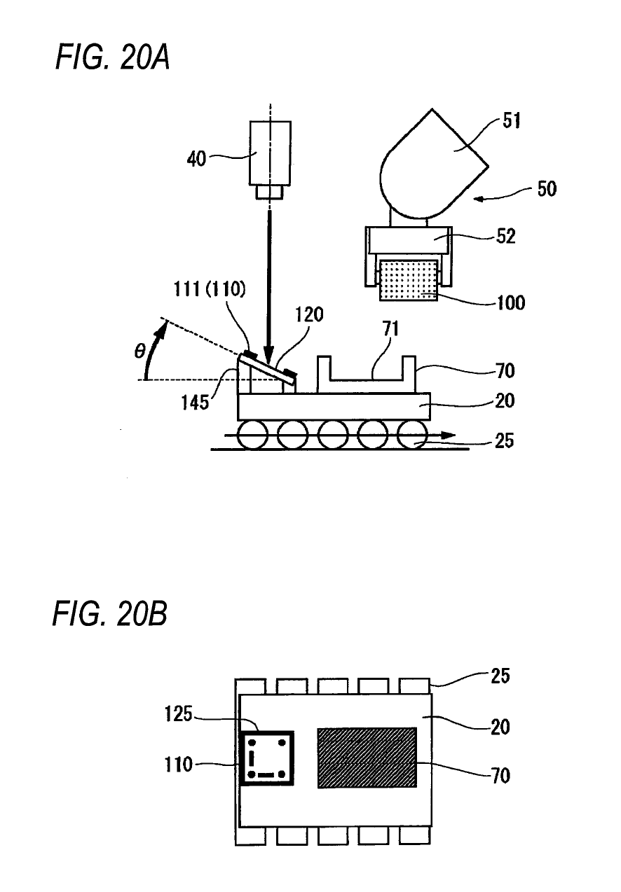

Further, as shown in FIGS. 20A and 20B, the card 120 given the pattern marker 110 is placed at the inclination angle θ with respect to the horizontal direction and at the corner of the top surface 22 of the assembly pallet 20 by way of an inclined support bed 145. In the meantime, the camera 40 is set in such a way that the imaging plane of the camera opposes the top surface 22 of the assembly pallet 20, thereby preventing the imaging plane of the camera 40 from directly facing up the surface of the pattern marker 110 on the card 120.

Even in the present configuration, the imaging plane of the camera 40 is set at the inclination angle θ with respect to the surface of the pattern marker 110 of the assembly pallet 20 as in the case of the configuration shown in FIGS. 18 and 19. Therefore, when the pattern marker 110 is measured at the non-face-up measurement position, a highly accurate measurement result is obtained with regard to the layout information about the pattern marker 110.

### Fourth Exemplary Embodiment

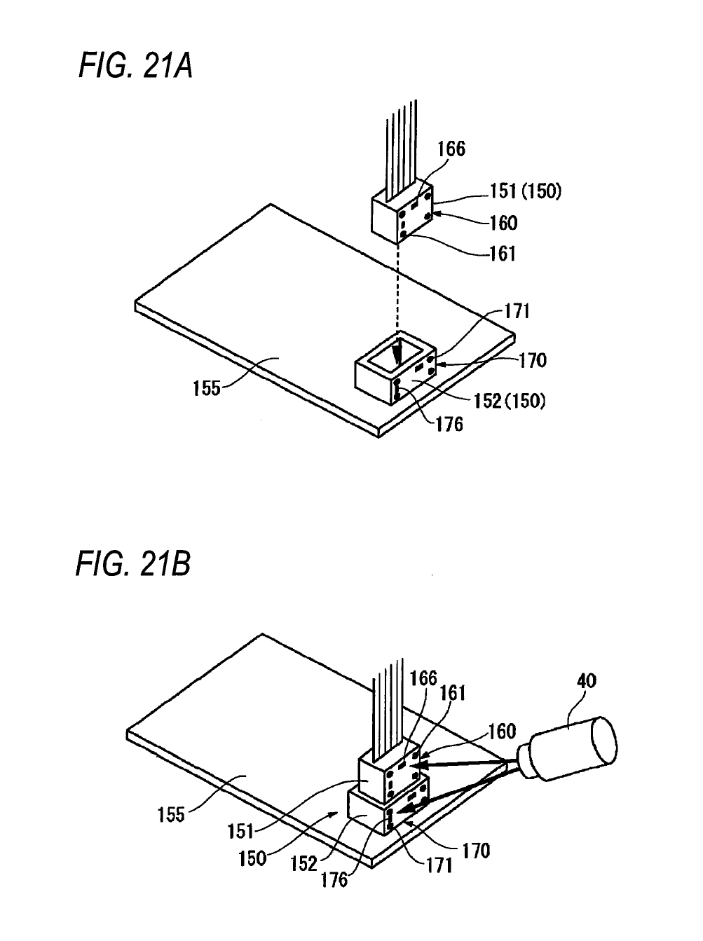

FIGS. 21A and 21B show a principal block of the assembly processing apparatus for assembling a connector device.

FIG. 21A is a descriptive view showing a state of a connector device 150 achieved before assembly, in which a male connector 151 and a female connector 152, which are elements of the connector device, are not yet inserted. FIG. 21B is a descriptive view showing a state in which assembly of the connector device is completed as a result of the male connector having been inserted into the female connector.

In the present exemplary embodiment, a pattern marker 160 is provided on one side surface of the male connector 151, and a pattern marker 170 is provided on one side surface of the female connector 152, wherein both side surfaces are on the same side. The pattern marker 160 has unit pattern marks 161 provided at four corners on the side surface and type indication marks 166 provided along two sides of the same side surface. Further, the pattern marker 170 has unit pattern marks 171 provided at four corners on the side surface and type indication marks 176 provided along two sides of the same side surface.

As shown in FIG. 21B, when the male connector 151 is assembled into the female connector 152, the camera 40 measures the pattern markers 160 and 170.

According to the measured imaging information, an unillustrated controller recognizes the layout information about the position and the attitude of the female connector 152 on a printed board 155. When an unillustrated robot grips the male connector 151, layout information about the position and the attitude of the male connector 151 may be recognized.

Moreover, the controller recognizes layout information about the position and the attitude of the pattern marker 160 of the male connector 151 and layout information about the position and the attitude of the pattern marker 170 of the female connector 152 and calculates a relative positional relationship between the pattern markers, whereby an assembled state of both the connectors may also be checked.

It is possible to accurately recognize the layout information about the male connector 151 and the layout information about the female connector 152 by assigning different type indication marks (IDs) to the pattern marker 160 of the male connector 151 and the pattern marker 170 of the female connector 152.

In the exemplary embodiment, the male connector 151 is provided with the pattern marker 160, and the female connector 152 is provided with the pattern marker 170. In; for instance, a configuration in which the female connector 152 is provided at a predetermined area on the printed board 155, the pattern marker is provided on the printed board 155 in lieu of the female connector 152. A relative positional relationship between the male connector and the female connector may be recognized by means of the pattern marker on the printed board and the pattern marker 160 of the male connector 151 inserted and put into the female connector 152.

What is claimed is:

1. A structure for recognizing a receiving assembly component, comprising:
a recognition reference plane that is provided in a portion of an assembly base on a predetermined area of which there is placed a receiving assembly component used for assembling an assembly component and that serves as a reference used for recognizing layout information about a position and an attitude of the assembly base; and
a recognition indicator element that is provided on the recognition reference plane so that an imaging tool performs imaging operation and that has, at a predetermined positional relationship, four unit pattern marks or more formed such that a density pattern of each of the unit pattern marks sequentially changes from a center position to a periphery of the mark.

2. The structure for recognizing a receiving assembly component according to claim 1, wherein the recognition indicator element corresponds to displaying a change in density pattern of the unit pattern mark as a dot image.

3. The structure for recognizing a receiving assembly component according to claim 1, wherein the recognition indicator element has four unit pattern marks provided on a single plane of an article to be recognized made up of the assembly base or the receiving assembly component.

4. The structure for recognizing a receiving assembly component according to claim 1, wherein the recognition indicator element is displayed on a card removably attached to an article to be recognized that is made up of an assembly base or a receiving assembly component.

5. The structure for recognizing a receiving assembly component according to claim 1, wherein the recognition indicator element has four unit pattern marks or more and type indication marks used for recognizing type information other than layout information about a position and an attitude of the article to be recognized made up of the assembly base or the receiving assembly component.

6. A structure for recognizing a receiving assembly component, comprising:
a recognition reference plane that is provided in a portion of an assembly base on a predetermined area of which there is placed a receiving assembly component used for assembling an assembly component and that serves as a reference used for recognizing layout information about a position and an attitude of the receiving assembly component; and
a recognition reference plane that is provided in a portion of a receiving assembly component used for putting an assembly component into a predetermined area of an assembly base and that has, at a predetermined positional relationship, four unit pattern marks or more formed such that a density pattern of each of the unit pattern marks sequentially changes from a center position to a periphery of the mark.

7. The structure for recognizing a receiving assembly component according to claim 6, wherein the recognition indicator element corresponds to displaying a change in density pattern of the unit pattern mark as a dot image.

8. The structure for recognizing a receiving assembly component according to claim 6, wherein the recognition indicator element has four unit pattern marks provided on a single plane of an article to be recognized made up of the assembly base or the receiving assembly component.

9. The structure for recognizing a receiving assembly component according to claim 6, wherein the recognition indicator element is displayed on a card removably attached to an article to be recognized that is made up of an assembly base or a receiving assembly component.

10. The structure for recognizing a receiving assembly component according to claim 6, wherein the recognition indicator element has four unit pattern marks or more and type indication marks used for recognizing type information other than layout information about a position and an attitude of the article to be recognized made up of the assembly base or the receiving assembly component.

11. An assembly information recognition apparatus comprising:
a recognition indicator element that is provided in a portion of an assembly base on a predetermined area of which there is placed a receiving assembly component used for assembling an assembly component or a portion of the receiving assembly component and that has, at a predetermined positional relationship, four unit pattern marks or more formed such that a density pattern of each of the unit pattern marks sequentially changes from a center position to a periphery of the mark;
an imaging tool that is disposed opposite the assembly base or the receiving assembly component and that captures an image of the recognition indicator element; and
a layout information recognition block that uses at least imaging information about the recognition indicator element whose image has been captured by the imaging tool, thereby recognizing layout information about a position and an attitude of the assembly base or the receiving assembly component.

12. An assembly processing apparatus comprising:
an assembly information recognition apparatus according to claim 11;
a control block that generates a control signal from layout information about the position and the attitude of the assembly base or the receiving assembly component recognized by the assembly information recognition apparatus and that controls operation of the assembly base for putting an assembly component to the receiving assembly component; and
a processing mechanism that performs operation for putting the assembly component into the receiving assembly component according to a control signal generated by the control block.

13. The assembly processing apparatus according to claim 12, wherein the processing mechanism doubles also as a mechanism for supporting the imaging tool.
